(19) United States
(12) Patent Application Publication
(10) Pub. No.: US 2025/0390694 A1
(43) Pub. Date: Dec. 25, 2025

(54) INFORMATION PROCESSING APPARATUS, CONTROL METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: NAGISA SAKATA, Kanagawa (JP)

(21) Appl. No.: 19/245,996

(22) Filed: Jun. 23, 2025

(30) Foreign Application Priority Data
Jun. 24, 2024 (JP) 2024-101545
Apr. 1, 2025 (JP) 2025-060810

(51) Int. Cl. G06K 15/02; H04N 1/34

(52) U.S. Cl. CPC G06K 15/1823; H04N 1/346

(57) ABSTRACT

An information processing apparatus includes at least one memory that stores a program, and at least one processor that executes the program to perform control to display a plurality of options indicating different numbers of sheets for adding a number of sheets permitted to be used for printing in a printer and control to, in association with a single option among the plurality of options, display information regarding a period corresponding to a number of sheets indicated in the single option.

### BACKGROUND

### Field

The present disclosure relates to display for adding the number of sheets that can be used for printing in a printer.

### Description of the Related Art

In recent years, many devices connect to the Internet. This has led to the “Internet of Things” (“IoT”) in which control data of various devices and operation data of the devices are transmitted to a cloud and used on a cloud. This is beginning to be widely prevalent. Similarly, a printer also connects to a cloud service.

The cloud service manages data of the number of sheets for printing in a printer, and printing can be performed within the number of sheets for printing purchased in advance.

In the publication of Japanese Patent Application Laid-Open No. 2011-35779, based on the execution history of accumulated jobs, the fees for a plurality of plans in a service are simulated, and the most inexpensive plan is presented to a user.

However, in the publication of Japanese Patent Application Laid-Open No. 2011-35779, it is not considered that the user selects any of options indicating the numbers of sheets, and adds the number of sheets that can be used for printing in a printer.

### SUMMARY

The present disclosure is directed to make it easy for the user to grasp an option for an appropriate number of sheets when a user adds the number of sheets that can be used for printing in a printer.

According to an aspect of the present disclosure, an information processing apparatus includes at least one memory that stores a program, and at least one processor that executes the program to perform control to display a plurality of options indicating different numbers of sheets for adding a number of sheets permitted to be used for printing in a printer and control to, in association with a single option among the plurality of options, display information regarding a period corresponding to a number of sheets indicated in the single option.

Further features of the present disclosure will become apparent from the following description of exemplary embodiments with reference to the attached drawings.

### BRIEF DESCRIPTION OF THE DRAWINGS

FIG. 1 is a diagram illustrating an overall configuration of a system according to a first exemplary embodiment.

FIGS. 2A and 2B are diagrams illustrating hardware configurations of image forming apparatuses, a client terminal, and a print service.

FIG. 3 is a diagram illustrating software configurations of the apparatuses included in the system.

FIGS. 4A and 4B are examples of screens for purchasing a number-of-sheets-for-printing charge according to the first exemplary embodiment.

FIGS. 5A to 5D are a sequence diagram and flowcharts according to the first exemplary embodiment.

FIGS. 6A to 6I are examples of screens according to a second exemplary embodiment.

FIG. 7 is a sequence diagram illustrating an entirety of a system according to the second exemplary embodiment.

FIG. 8 is a flowchart according to the second exemplary embodiment.

FIGS. 9A to 9D are a sequence diagram and flowcharts according to a third exemplary embodiment.

FIG. 10 is an example of a screen according to the third exemplary embodiment.

### DESCRIPTION OF THE EMBODIMENTS

With reference to the drawings, the best mode for carrying out the present disclosure will be described.

A first exemplary embodiment of the present disclosure is described.

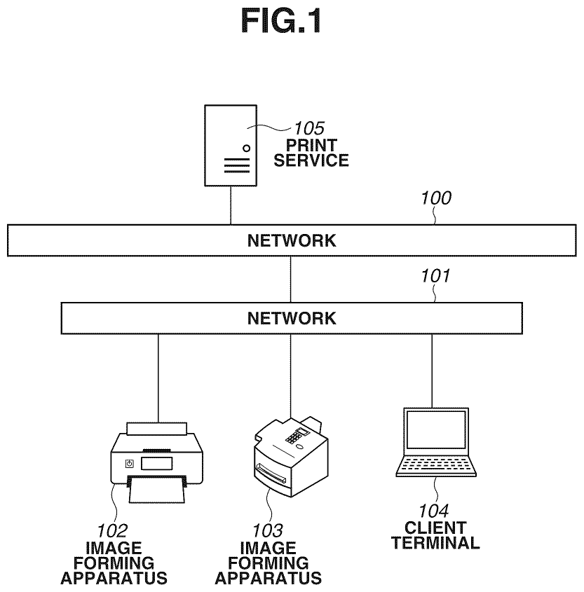

FIG. 1 is a diagram illustrating the overall configuration of an information processing system according to the exemplary embodiment of the present disclosure.

In FIG. 1, networks 100 and 101 are exemplary communication networks achieved by, for example, a local area network (LAN) for the Internet, a wide area network (WAN), a telephone circuit, a dedicated digital circuit, an Asynchronous Transfer Mode (ATM) or frame relay circuit, a cable television circuit, and a data broadcasting wireless circuit. The networks 100 and 101 may only need to enable the transmission and reception of data. In the specification, the network 100 is the Internet. The network 101 is a local network.

An image forming apparatus 102, an image forming apparatus 103, and a client terminal 104 can access the Internet 100 via the local network 101 and access a print service 105.

Each of the image forming apparatuses 102 and 103 is a multifunction peripheral or a printer having a print function, a copy function, a scanner function, and a fax transmission function. Each of the image forming apparatuses 102 and 103 is an example of a printer according to the present disclosure. For example, that is, each of the image forming apparatuses 102 and 103 may be a printer having only a print function.

The client terminal 104 is a data processing apparatus such as a personal computer, a smartphone, or a mobile terminal for using a cloud service. The client terminal 104 transmits a print job to each of the image forming apparatuses 102 and 103 and gives a print instruction to the print service 105.

The network 101 is a LAN to which the image forming apparatus 102, the image forming apparatus 103, and the client terminal 104 are connected. The image forming apparatus 102, the image forming apparatus 103, the client terminal 104, and the print service 105 communicate with each other via the LAN.

The print service 105 is a server for providing a print service. The print service 105 manages a contract for the print service and provides functions related to printing. The print service 105 holds contract information regarding contracts with users. In the present exemplary embodiment, a user registers a service plan, user information, and the image forming apparatuses 102 and 103 in the print service 105 via the client terminal 104, whereby the print service 105 holds contract information regarding the user.

The print service 105 gives a print instruction to either of the devices registered in the contract information. If the print service 105 receives data from either of the devices registered in the registration information, the print service 105 performs processes corresponding to the received data.

The print service 105 is published as cloud services made redundant by a plurality of servers on the Internet. The functions of the services may be achieved by a single server or a single virtual server, or may be achieved by a plurality of servers or a plurality of virtual servers. Alternatively, a plurality of virtual servers may be executed on a single server.

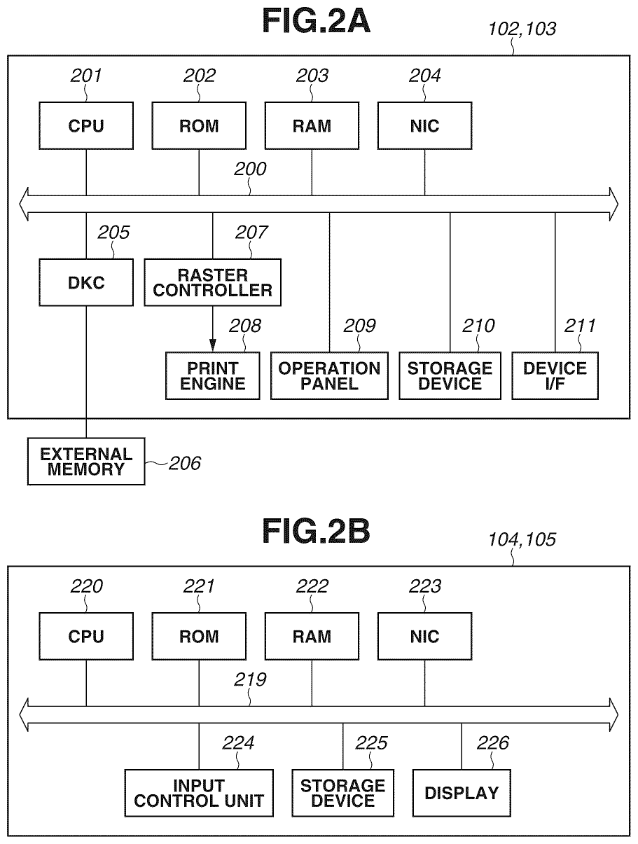

FIG. 2A is a diagram illustrating the hardware configuration of each of the image forming apparatuses 102 and 103 according to the exemplary embodiment of the present disclosure. The components of the hardware are connected to a system bus 200.

A central processing unit (CPU) 201 controls the entirety of the apparatus and performs overall control of access to and from various blocks connected to the system bus 200. This control is based on a control program stored in a read-only memory (ROM) 202 or a control program and resource data (resource information) stored in an external memory 206 connected to the image forming apparatus 102 or 103 via a disk controller (DKC) 205. A random-access memory (RAM) 203 functions as a main memory or a work area for the CPU 201 and is configured to expand the memory capacity using an optional RAM connected to an additional port (not illustrated). A storage device 210 functions as a large-capacity memory. An operation panel (operation unit) 209 displays a screen or receives an operation instruction given by a user through the screen. In the operation panel (operation unit) 209, a button and a display unit such as a liquid crystal panel for setting the operation mode of the image forming apparatus 102 or 103, displaying the operating state of the image forming apparatus 102 or 103, or performing an operation of specifying copying are also placed. Via a network interface card (NIC) 204, the image forming apparatus 102 or 103 exchanges data with an external apparatus. A print engine 208 illustrated in FIG. 2A uses a known printing technique. Examples of a suitable system for achieving the print engine 208 include an electrophotographic method (a laser beam method), an inkjet method, and a sublimation (thermal transfer) method. A raster controller 207 is a controller that converts print data in a page description language (PDL) language or a Portable Document Format (PDF) language into image data. A device interface (I/F) 211 is a connection I/F with an external device capable of connecting to the image forming apparatus 102 or 103 based on Universal Serial Bus (USB).

FIG. 2B is a diagram illustrating the hardware configuration of each of the client terminal 104 and the print service 105 according to the exemplary embodiment of the present disclosure.

Unless otherwise noted, the present disclosure can be applied to both a single device and a system composed of a plurality of devices so long as the functions of the present disclosure can be executed. Unless otherwise noted, the present disclosure can also be applied to a system where connections are made via a network such as a LAN or a WAN and processing is performed so long as the functions of the present disclosure can be executed. The present exemplary embodiment is described on the assumption that the components are connected together by a system bus 219.

A CPU 220 is a control device for an information processing apparatus that is the client terminal 104 or the print service 105. The CPU 220 executes an application program and an operating system (OS) stored in a storage device 225 and performs control to temporarily store information and a file required to execute a program in a RAM 222. A ROM 221 is a storage unit and stores a program such as a basic input/output (I/O) program and various pieces of data inside. The RAM 222 is a temporary storage unit and functions as a main memory or a work area for the CPU 220. Via an input control unit 224, the information processing apparatus exchanges data with an external apparatus. The storage device 225 is one of external storage units and functions as a large-capacity memory. The storage device 225 stores the application program and the OS. A display unit 226 displays the result of executing a program and information required for an input operation. The display unit 226 may be a device also having the function of receiving an operation instruction from a user, such as a touch panel.

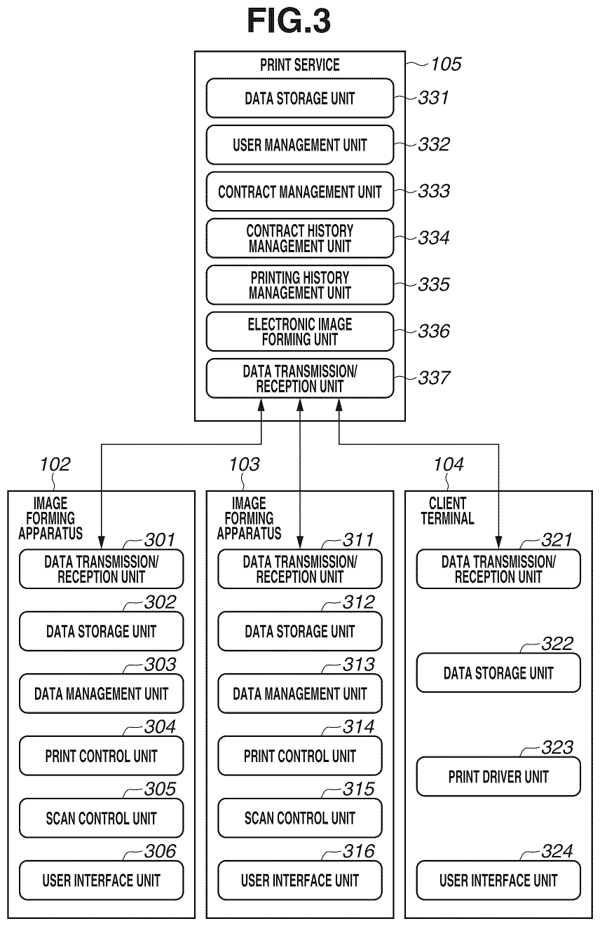

FIG. 3 illustrates a software configuration in which functions related to the present disclosure are excerpted in the image forming apparatus 102, the image forming apparatus 103, the client terminal 104, and the print service 105 according to the present exemplary embodiment. Software modules are stored in the storage devices 210 and 225 illustrated in FIGS. 2A and 2B and are loaded into the RAMs 203 and 222 by the CPUs 201 and 220 and executed by the CPUs 201 and 220, respectively, as described above.

The image forming apparatus 102 includes a data transmission/reception unit 301, a data storage unit 302, a data management unit 303, a print control unit 304, a scan control unit 305, and a user interface unit 306. The image forming apparatus 103 has a configuration similar to that of the image forming apparatus 102 and includes a data transmission/reception unit 311, a data storage unit 312, a data management unit 313, a print control unit 314, a scan control unit 315, and a user interface unit 316. The data transmission/reception units 301 and 311 transmit printing result information regarding the image forming apparatuses 102 and 103, respectively, to the print service 105 or receive data such as a print instruction from the print service 105. Each of the data storage units 302 and 312 saves data input by a user and device information. The data management units 303 and 313 manage data by saving data in the data storage units 302 and 312 or updating and deleting data saved in the data storage unit 302 and 312, respectively. The user interface units 306 and 316 receive inputs from the user, and according to the contents of the inputs, perform printing using the print control units 304 and 314 or perform scanning using the scan control units 305 and 315, respectively.

The client terminal 104 includes a data transmission/reception unit 321, a data storage unit 322, a print driver unit 323, and a user interface unit 324. The data transmission/reception unit 321 transmits data such as a print instruction to each of the image forming apparatuses 102 and 103 or receives data such as scan data from each of the image forming apparatuses 102 and 103. The data transmission/reception unit 321 transmits data such as an information registration instruction and a print instruction to the print service 105 or receives data such as contract information and printing history information from the print service 105. The data storage unit 322 saves data regarding the image forming apparatuses 102 and 103 and user information regarding the print service 105. The print driver unit 323 gives a print instruction to each of the image forming apparatuses 102 and 103 directly or via the print service 105.

The user interface unit 324 receives an input from a user, and according to the content of the input, the client terminal 104 gives an instruction to each of the image forming apparatuses 102 and 103 or gives an instruction to the print service 105.

The print service 105 includes a data storage unit 331, a user management unit 332, a contract management unit 333, a contract history management unit 334, a printing history management unit 335, an electronic image forming unit 336, a user interface unit, and a data transmission/reception unit 337.

The data storage unit 331 saves data of a contract, data of a user, data of a device, and printing history registered in the print service 105.

The user management unit 332 manages a user by saving user data of a user who uses the print service 105 in the data storage unit 331 or updating and deleting user data saved in the data storage unit 331. The following table 1 illustrates an example of data managed by the user management unit 332.

TABLE 1
User Management Table

| | | | Login | People | Junior High School | Elementary |
|---|---|---|---|---|---|---|
| User | | Login | Expiration | Aged 18 | Students/High | School Students |
| ID | Password | State | Date | or Older | School Students | or Younger |
| User | ********* | On | 2022/12/31 | 2 | 1 | 0 |
| A | | | 0:00 | | | |
| User | ********* | On | 2022/12/31 | 1 | 0 | 0 |
| B | | | 0:00 | | | |
| User | ********* | Off | | 2 | 1 | 1 |
| C | | | | | | |

A “user ID” column indicates an identifier (ID) for uniquely identifying a user. A “password” column indicates a password for basic authentication used when a login is performed using a user ID. The user management unit 332 checks the combination of a user ID and a password included in a login request from the client terminal 104 against table 1. If the combination matches table 1, the user management unit 332 returns a login result indicating success to the client terminal 104.

A “login state” column indicates the login state of a user. “On” indicates a logged-in state, and “off” indicates a logged-out state. A “login expiration date” column indicates the expiration date of the authentication state of a logged-in user. A “people aged 18 or older” column indicates the number of people aged 18 or older among people using the account of a certain user ID in a shared manner. A “junior high school students/high school students” column indicates the number of junior high school students and high school students among people using the account of a certain user ID in a shared manner. An “elementary school students or younger” column indicates the number of elementary school students or younger among people using the account of a certain user ID in a shared manner.

The contract management unit 333 manages a number-of-sheets-for-printing included in a charge plan provided by the print service 105 by saving data of a pre-paid plan charging based on the number of pages to be printed in the data storage unit 331 or updating and deleting a pre-paid plan saved in the data storage unit 331. The contract management unit 333 manages the remaining number of sheets of a number-of-sheets-for-printing charge of a user or a device, or calculates the predicted value of the number of sheets for printing of a user and selects a recommended pre-paid plan.

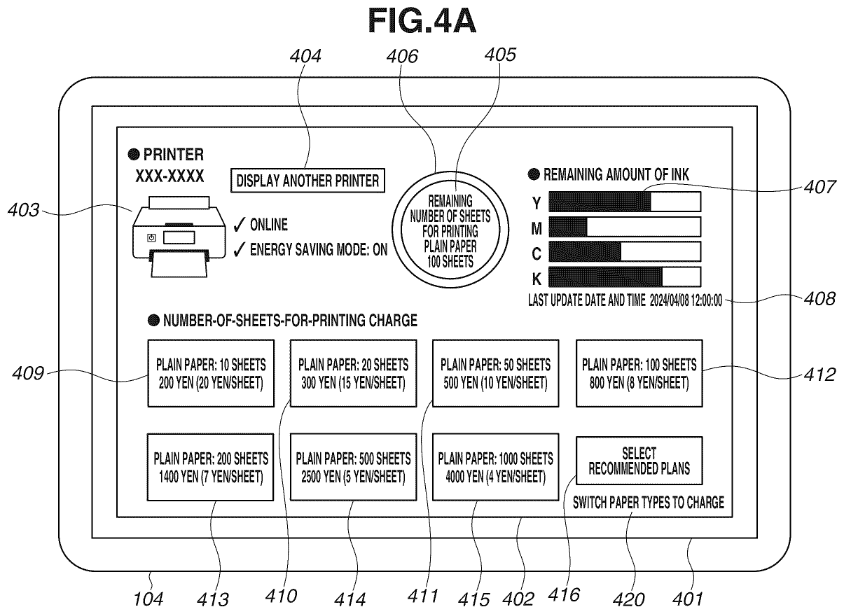

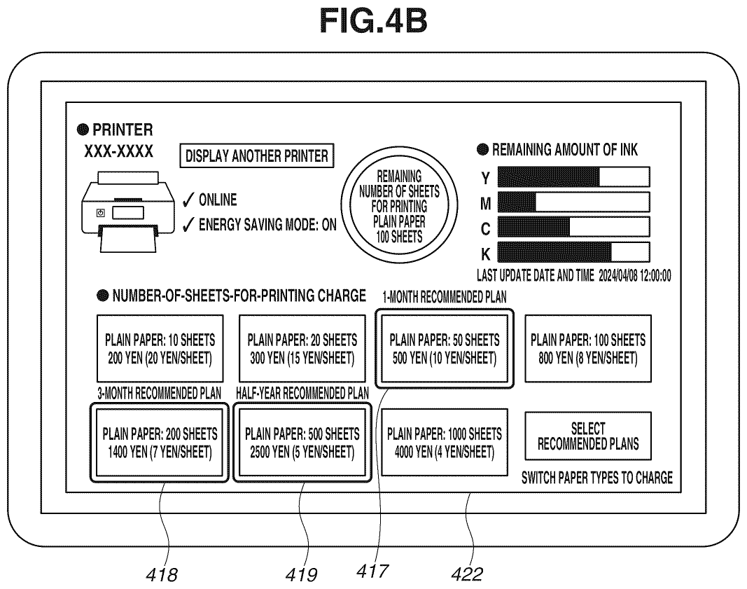

A pre-paid plan is described. Each of the image forming apparatuses 102 and 103 can execute printing on the allowed number of sheets. Each of the image forming apparatuses 102 and 103 is controlled not to execute printing on sheets exceeding the allowed number of sheets. A user can add the number of sheets for printing allowed by the image forming apparatus 102 or 103 via the client terminal 104. The addition of the number of sheets for printing is referred to as a “number-of-sheets-for-printing charge”. The number of sheets for printing that can be added at a time is defined by a plan illustrated in table 2. The client terminal 104 displays a plurality of options indicating different numbers of sheets as illustrated in plans A to G in table 2. The details will be described with reference to FIGS. 4A and 4B. The user can add the number of sheets for printing by selecting one of the plurality of options and paying a corresponding price.

Table 2 illustrates examples of a pre-paid plan managed by the contract management unit 333.

TABLE 2
Pre-paid Plan Management Table

| Plan ID | Sheets | Number of Sheets | Price |
|---|---|---|---|
| Plan A | Plain paper | 10 sheets | 200 yen |
| Plan B | Plain paper | 20 sheets | 300 yen |
| Plan C | Plain paper | 50 sheets | 500 yen |
| Plan D | Plain paper | 100 sheets | 800 yen |
| Plan E | Plain paper | 200 sheets | 1400 yen |
| Plan F | Plain paper | 500 sheets | 2500 yen |
| Plan G | Plain paper | 1000 sheets | 4000 yen |
| Plan H | Photograph sheets | 10 sheets | 300 yen |
| Plan I | Postcards | 10 sheets | 250 yen |

A “plan ID” column indicates an ID for uniquely identifying a pre-paid plan provided by the print service 105. A “sheets” column indicates which of plain paper, photograph sheets, and postcards sheets to be used for printing in each pre-paid plan are. A “number of sheets” column indicates the number of sheets for printing that can be purchased in each pre-paid plan. A “price” column indicates the purchase price of each pre-paid plan.

The following table 3 illustrates examples of the remaining number of sheets of a number-of-sheets-for-printing charge of a user or a device managed by the contract management unit 333.

TABLE 3
Contract State Management Table

| | | | Remaining Number | Remaining Number of | Remaining Number |
|---|---|---|---|---|---|
| User | Device | | of Sheets of Plain | Sheets of Photograph | of Sheets of |
| ID | ID | Model | Paper | Sheets | Postcards |
| User | Device | Model | 100 sheets | 0 sheets | 0 sheets |
| A | A | A | | | |
| | Device | Model | | | |
| | D | D | | | |
| User | Device | Model | 200 sheets | 40 sheets | 10 sheets |
| | B | B | | | |
| B | Device | Model | | | |
| | E | E | | | |
| User | Device | Model | 10 sheets | 0 sheets | 0 sheets |
| C | C | C | | | |

A “user ID” column indicates a user ID. A user ID is an ID for uniquely identifying a user and indicates a user managed in the user management table in table 1. A “device ID” column indicates an ID for uniquely identifying a device and indicates a device to be used in a contract. A “model” column indicates the model name of a device to be used in a contract by a user and managed in the “device ID” column. A “remaining number of sheets of plain paper” column indicates the remaining number of sheets of a number-of-sheets-for-printing charge of plain paper. A “remaining number of sheets of photograph sheets” column indicates the remaining number of sheets of a number-of-sheets-for-printing charge of photograph sheets. A “remaining number of sheets of postcards” column indicates the remaining number of sheets of a number-of-sheets-for-printing charge of postcards.

The following table 4 illustrates examples of the average number of sheets for printing per month with respect to each of the models of the devices managed by the contract management unit 333.

TABLE 4
Average-Number-of-Sheets-for-Printing-per-Month-
with-Respect-to-Each-Model Management Table

| | Number of Sheets for | Number of Sheets for Printing | Number of Sheets for |
|---|---|---|---|
| Model | Printing on Plain Paper | on Photograph Sheets | Printing on Postcards |
| Model | 100 sheets | None | None |
| A | | | |
| Model | 150 sheets | 20 sheets | 20 sheets |
| B | | | |
| Model | 70 sheets | 5 sheets | None |
| C | | | |
| Model | 50 sheets | None | None |
| D | | | |
| Model | 100 sheets | None | 10 sheets |
| E | | | |

A “model” column indicates the model name of the same device as that managed in the contract state management table in table 3. A “number of sheets for printing on plain paper” column indicates the average number of sheets for printing on plain paper on which a model in the “model” column performs printing per month. A “number of sheets for printing on photograph sheets” column indicates the average number of sheets for printing on photograph sheets on which a model in the “model” column performs printing per month. In the case of a model incompatible with printing on photograph sheets, the value of the “number of sheets for printing on photograph sheets” column is “none”. A “number of sheets for printing on postcards” column indicates the average number of sheets for printing on postcard sheets on which a model in the “model” column performs printing per month. In the case of a model incompatible with printing on postcard sheets, the value of the “number of sheets for printing on postcards” column is “none”.

The contract history management unit 334 manages the purchase history of a pre-paid plan by a user. The following table 5 illustrates examples of the purchase history of a pre-paid plan managed by the contract history management unit 334.

TABLE 5
Purchase-History-of-Number-of-Sheets-for-Printing-Charge-Plan Management

| User ID | Plan ID | Number of Sheets | Amount of Payment | Date and Time |
|---|---|---|---|---|
| User A | Plan D | 100 plain paper sheets | 800 yen | 2023 Jan. 3 |
| | | | | 12:00 |
| User B | Plan C | 50 plain paper sheets | 500 yen | 2023 Jan. 5 |
| | | | | 12:00 |
| User B | Plan B | 20 plain paper sheets | 300 yen | 2023 Jan. 5 |
| | | | | 13:00 |
| User C | Plan A | 10 plain paper sheets | 200 yen | 2023 Jan. 6 |
| | | | | 18:00 |
| User B | Plan E | 200 plain paper sheets | 1400 yen | 2023 Jan. 20 |
| | | | | 19:00 |

A “user ID” column indicates a user ID. A user ID is an ID for uniquely identifying a user and indicates a user managed in the user management table in table 1. A “plan ID” column indicates a plan ID. A plan ID is an ID for uniquely identifying a pre-paid plan and indicates a plan managed in the pre-paid plan management table in table 2. A “number of sheets” column indicates the content of a pre-paid plan purchased by a user. An “amount of payment” column indicates the price paid to purchase a pre-paid plan by a user. A “date and time” column indicates the date and time when a user purchases a pre-paid plan.

The printing history management unit 335 manages printing history by saving data of a printing result received from each of the image forming apparatuses 102 and 103 in the data storage unit 331 or generating printing history from a printing result saved in the data storage unit 331. The following table 6 illustrates examples of the printing history managed by the printing history management unit 335.

TABLE 6
Printing History Management Table

| Device ID | Document | Page | Printing Sheets | Date and Time |
|---|---|---|---|---|
| Device A | ABC.pdf | 1/3 | Plain paper | 2023 Jan. 2 |
| | | | | 12:00 |
| Device A | ABC.pdf | 2/3 | Plain paper | 2023 Jan. 3 |
| | | | | 12:00 |
| Device A | ABC.pdf | 3/3 | Plain paper | 2023 Jan. 4 |
| | | | | 12:00 |
| Device C | XYZ.pptx | 1/1 | Photograph sheets | 2023 Jan. 5 |
| | | | | 18:00 |
| Device B | QWE.pdf | 1/1 | Postcards | 2023 Jan. 20 |
| | | | | 19:00 |

A “device ID” column indicates an ID for uniquely identifying a device and indicates a device that performs printing. A “document” column indicates the document name of a printed document. A “page” column indicates which page of a document is printed in a numerator, and indicates the total number of pages of the document in a denominator. A “printing sheets” column indicates which of plain paper, photograph sheets, and postcards are used as printing sheets when printing is performed. A “date and time” column indicates the date and time when printing is performed.

The following table 7 indicates the actual result value of printing and the predicted value of the number of sheets for printing per past month managed by the printing history management unit 335.

TABLE 7
Printing Actual Result Value Table

| | | | | Actual | | Actual | | |
|---|---|---|---|---|---|---|---|---|
| | | | Prediction | Result | Prediction of | Result of | | Actual |
| Device | | | of Plain | of Plain | Photograph | Photograph | Prediction of | Result of |
| ID | Year | Month | Paper | Paper | Sheets | Sheets | Postcards | Postcards |
| Device | 2023 | 1 | 100 | 60 | 0 | 0 | 0 | 0 |
| A | | | | | | | | |
| Device | 2023 | 2 | 100 | 80 | 0 | 0 | 0 | 0 |
| A | | | | | | | | |
| Device | 2023 | 3 | 100 | 120 | 0 | 0 | 0 | 0 |
| A | | | | | | | | |
| Device | 2023 | 3 | 50 | 60 | 20 | 30 | 10 | 8 |
| C | | | | | | | | |
| Device | 2023 | 3 | 60 | 35 | 10 | 20 | 5 | 20 |
| B | | | | | | | | |

A “device ID” column indicates an ID for uniquely identifying a device and indicates a device that performs printing. A “year” column indicates the year when printing is performed. A “month” column indicates the month when printing is performed. A “prediction of plain paper” column indicates the predicted value of the number of sheets for printing on plain paper. An “actual result of plain paper” column indicates the actual result value of the number of sheets for printing on plain paper. A “prediction of photograph sheets” column indicates the predicted value of the number of sheets for printing on photograph sheets. An “actual result of photograph sheets” column indicates the actual result value of the number of sheets for printing on photograph sheets. A “prediction of postcards” column indicates the predicted value of the number of sheets for printing on postcards. An “actual result of postcards” column indicates the actual result value of the number of sheets for printing on postcards.

In a case where the print service 105 gives a print instruction to the image forming apparatus 102 or 103, the electronic image forming unit 336 generates electronic data of a print job to be transmitted as the print instruction. The print service 105 transmits the electronic data to the image forming apparatus 102 or 103, whereby the image forming apparatus 102 or 103 having received the electronic data executes printing. The user interface unit receives an input from a user, and according to the content of the input, gives an instruction to the data transmission/reception unit 337.

The data transmission/reception unit 337 transmits data such as a print instruction to each of the image forming apparatuses 102 and 103 or receives data such as operation data from each of the image forming apparatuses 102 and 103. The data transmission/reception unit 337 receives data such as an information registration instruction or a print instruction from the client terminal 104 or transmits data of a recommended pre-paid plan selected by the contract management unit 333 to the client terminal 104. The data transmission/reception unit 337 transmits a screen to the client terminal 104.

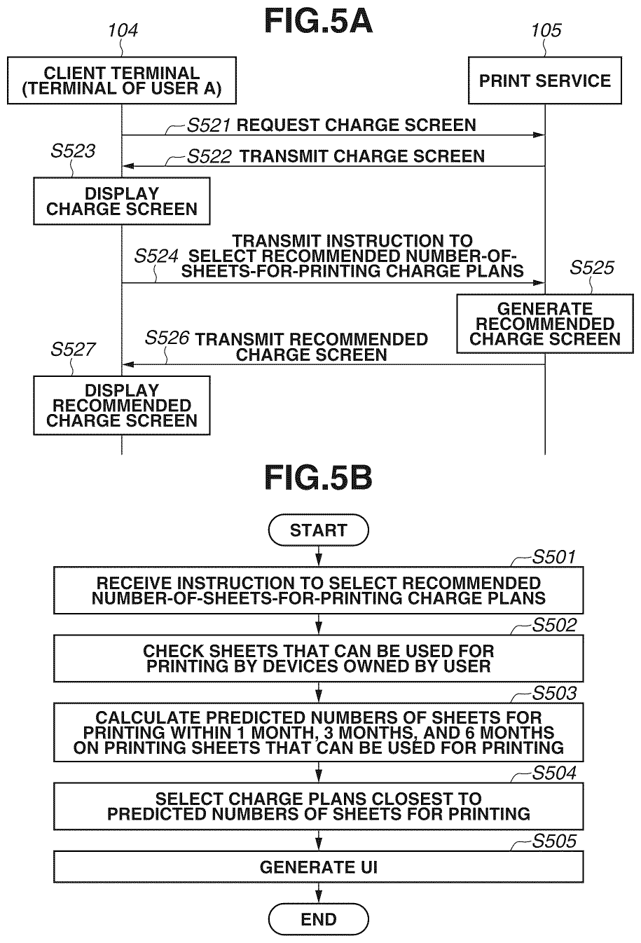

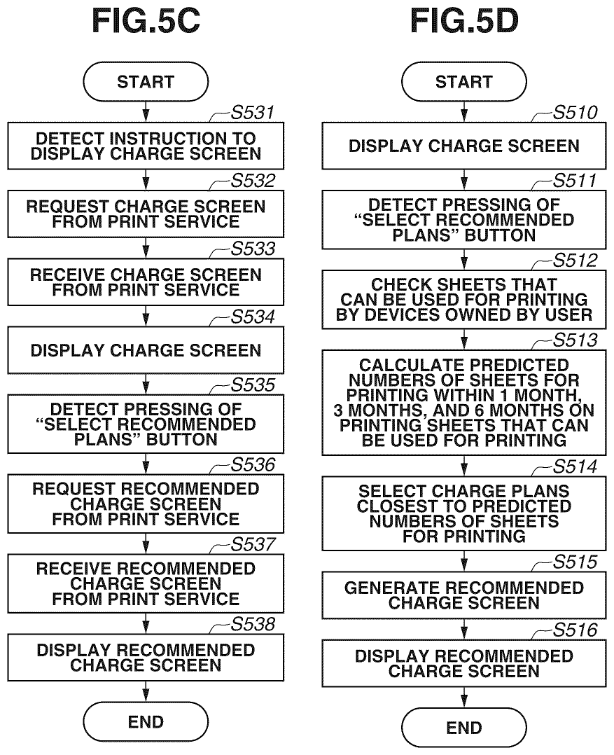

With reference to FIGS. 4A, 4B, 5A, 5B, 5C, and 5D, a description is given of a method for, in a prepaid service where a user purchases the number of sheets for printing in advance, presenting optimal pre-paid plans to the user in an information processing system and a program to which the present disclosure is directed.

FIGS. 4A and 4B illustrate examples of user interfaces (UIs) displayed on the display unit 226 of the client terminal 104 and generated by the contract management unit 333 of the print service 105 according to the present exemplary embodiment.

FIGS. 5A to 5D are a sequence diagram and flowcharts illustrating processing until a user acquires information regarding pre-paid plans recommended to the user on a purchase screen for purchasing a pre-paid plan.

The present exemplary embodiment is described on the assumption that a user who operates the client terminal 104 is a user corresponding to a user A in the “user ID” column in each of tables 1 and 3. The user A is a user who uses the image forming apparatuses 102 and 103, the image forming apparatus 102 is a device corresponding to a device A in the “device ID” column in table 3, and the image forming apparatus 103 is a device corresponding to a device D in the “device ID” column in table 3.

First, FIG. 4A is described. An item 401 is the display unit 226 of the client terminal 104 used by the user A and displays an example of a UI of a screen where the user A according to the present exemplary embodiment purchases a number-of-sheets-for-printing charge provided by the print service 105. A UI 402 is the example of the UI of the screen where the user A purchases a number-of-sheets-for-printing charge provided by the print service 105. The UI 402 is referred to as a “charge screen”. The charge screen 402 is a screen for adding the number of sheets that can be used for printing in the image forming apparatus 102 or 103. The “number of sheets that can be used for printing” refers to the number of sheets permitted to be used for printing in the image forming apparatus 102 or 103. An item 403 displays an image and the model name of the image forming apparatus 102, which is the device corresponding to the device A in the “device ID” column in each of tables 3 and 4 used by the user, and the online state and the state of the energy saving mode of the device. In a button 404, a message “display another printer” is written. An item 405 indicates the remaining number of sheets of a number-of-sheets-for-printing charge of the user. That is, the item 405 indicates the remaining number of sheets that can be used for printing in the image forming apparatus 102. A circle chart 406 indicates what percentage of the remaining number of sheets of a number-of-sheets-for-printing charge at the time of purchase of a previous number-of-sheets-for-printing charge the current remaining number of sheets of the number-of-sheets-for-printing charge indicated by the item 405 accounts for. In a case where the price systems of pre-paid plans differ according to the printing types, a plurality of items 405 and a plurality of circle charts 406 are displayed with respect to each printing type. A bar graph 407 indicates the remaining amount of ink of the device displayed in the item 403 with respect to each ink type. An item 408 indicates the date and time when the information in the items 403, 405, 406, and 407 is acquired last from the image forming apparatus 102 displayed in the item 403. If the button 404 is pressed, information regarding another device with which the user is under contract for a service plan can be displayed in the items 403, 405, 406, and 407. In the present exemplary embodiment, if the button 404 is pressed, information regarding the image forming apparatus 103 can be displayed in the items 403, 405, 406, and 407. Alternatively, if the button 404 is pressed, a screen that allows the user to select another device may be displayed.

Buttons 409, 410, 411, 412, 413, 414, and 415 illustrate purchase buttons for number-of-sheets-for-printing charges. These buttons are a plurality of options indicating different numbers of sheets for adding the number of sheets that can be used for printing in the image forming apparatus 102 or 103. Each of these options (buttons) indicates the number of sheets for printing. The option (button) indicates the price to be paid by the user to charge the indicated number of sheets for printing. Further, the option (button) indicates the price per sheet calculated based on the indicated price and the indicated number of sheets for printing. Further, the option (button) also indicates a paper type. If any of the plurality of options is pressed, the charge screen 402 can transition to a purchase procedure screen (not illustrated) for the number-of-sheets-for-printing charge written in the button. The number of purchase buttons for number-of-sheets-for-printing charges displayed on the charge screen 402 may be greater or smaller than seven. A button 416 illustrates a button for giving an instruction to select recommended pre-paid plans. If the button 416 is pressed, recommended pre-paid plans can be displayed on a UI. Alternatively, a UI that displays recommended pre-paid plans can be displayed on the item 401. This UI is a UI in FIG. 4B.

A button 420 illustrates a button for giving an instruction to switch paper types for which number-of-sheets-for-printing charges are performed. If the button 420 is pressed, pre-paid plans indicated in the purchase buttons 409, 410, 411, 412, 413, 414, and 415 for number-of-sheets-for-printing charges can be switched to other paper types.

FIG. 4B is described. Contents similar to those in FIG. 4A are not designated by reference numbers and not described. A UI 422 illustrated in FIG. 4B is displayed if the button 416 in FIG. 4A is pressed. This UI is referred to as a “recommended charge screen”.

Items 417, 418, and 419 each illustrate a frame indicating a recommended pre-paid plan and a message including a use period. The items 417, 418, and 419 are displayed on the screen after the button 416 is pressed. Recommended pre-paid plans are selected by pressing the button 416. Then, the items 417, 418, and 419 highlight any of the plans in the buttons 409, 410, 411, 412, 413, 414, and 415 selected as the recommended pre-paid plans. Consequently, the recommended pre-paid plans are displayed on the UI.

A recommended pre-paid plan is a charge plan for the number of sheets estimated to be used for printing within a predetermined period in the image forming apparatus 102. In association with a single option indicating the number of sheets estimated to be used for printing within a single predetermined period among the plurality of buttons 409 to 415, information regarding the single predetermined period and information indicating that the single option is a recommended option are displayed. In FIG. 4B, for example, the words “one-month recommended plan” are displayed in association with the button 411 indicating the number of sheets estimated to be used for printing within one month (50 sheets). The words “3-month recommended plan” are displayed in association with the button 413 indicating the number of sheets estimated to be used for printing within three months (200 sheets). The words “half-year recommended plan” are displayed in association with the button 414 indicating the number of sheets estimated to be used for printing within a half year (500 sheets).

The number of sheets estimated to be used for printing within the predetermined period differs depending on which of one month, three months, and a half year, for example, the predetermined period is set to. The price per sheet differs with respect to each charge plan. For example, in a plan for 1000 sheets, the price per sheet is 4 yen. In a plan for 10 sheets, the price per sheet is 20 yen. As described above, in the present exemplary embodiment, basically, the greater the number of sheets to be purchased at a time in the plan is, the smaller the price per sheet is. Thus, the period for which the user wishes to charge the number of sheets for printing at a time differs depending on the user. For example, it is considered that some user wishes to charge the number of sheets for printing for each month while viewing the printing status, and some user wishes to charge the number of sheets for printing for a half year at a time, thereby charging the number of sheets for printing with a smaller price. It is possible to handle a variety of users by displaying recommended charge plans for a plurality of predetermined periods.

An overall sequence is described with reference to FIG. 5A.

In step S521, the client terminal 104 transmits an instruction to request the charge screen 402 to the print service 105. In step S522, the print service 105 transmits the charge screen 402 to the client terminal 104. In step S523, the client terminal 104 displays the received charge screen 402.

In step S524, the client terminal 104 transmits an instruction to select recommended pre-paid plans to the print service 105. In step S525, the print service 105 generates the recommended charge screen 422. The detailed processing will be described with reference to FIG. 5B. In step S526, the print service 105 transmits the generated recommended charge screen 422 to the client terminal 104. In step S527, the client terminal 104 displays the received recommended charge screen 422.

In FIG. 5A, a form has been described in which the print service 105 generates a screen, and the print service 105 transmits the screen to the client terminal 104. The present disclosure, however, is not limited to this. For example, in step S525, the print service 105 may not generate the screen, and in step S526, the print service 105 may transmit information regarding recommended charge plans to the client terminal 104. The client terminal 104 may receive the information, generate the recommended charge screen 422 based on the information, and display the recommended charge screen 422. Alternatively, the client terminal 104 may display the information regarding the recommended charge plans on top of the charge screen 402. For example, the information regarding the recommended charge plans transmitted from the print service 105 to the client terminal 104 is information regarding predetermined periods and information regarding charge plans for the numbers of sheets estimated to be used for printing within the predetermined periods.

The processing flow of the print service 105 in steps S524 and S525 is described in FIG. 5B. Before this flow, the button 416 for giving an instruction to select recommended pre-paid plans on the screen 402 for purchasing a number-of-sheets-for-printing charge displayed on the client terminal 104 of the user A is pressed. This flow is started if the data transmission/reception unit 321 of the client terminal 104 of the user A transmits the input instruction to select recommended pre-paid plans to the data transmission/reception unit 337. This flow is processing performed by the components of the print service 105.

In step S501, the data transmission/reception unit 337 receives the instruction to select recommended pre-paid plans, and transmits the received instruction to the contract management unit 333.

In step S502, the contract management unit 333 refers to the contract state management table in table 3 saved in the data storage unit 331 and checks printing sheets that can be used for printing by the models of the devices owned by the user. The models of the device owned by the user A are models A and D, and therefore, the printing sheets that can be used for printing are only plain paper.

In step S503, the contract management unit 333 calculates the predicted numbers of sheets for printing within a plurality of periods, namely one month, three months, and six months. Specifically, the calculations of the predicted numbers of sheets for printing are made as follows. With respect to each of the types of the printing sheets that can be used for printing by the devices owned by the user A, the contract management unit 333 refers to the contract state management table in table 3 and the average-number-of-sheets-for-printing-per-month-with-respect-to-each-model management table in table 4 saved in the data storage unit 331. The contract management unit 333 calculates the total average number of sheets used by the subscription participating devices owned by the user×the periods. For example, a calculation formula for the predicted number of sheets for printing on plain paper of the user A is the total average number of sheets used by the subscription participating devices owned by the user A (100 sheets per month (the model A)+50 sheets per month (the model D))×the periods (one month, three months, and six months). The results of the calculations of the predicted numbers of sheets for printing of the user A are 150 sheets within one month, 450 sheets within three months, and 900 sheets within six months. The predicted numbers of sheets for printing on photograph sheets and postcard sheets that cannot be used for printing by the devices owned by the user A are not calculated.

In step S504, the contract management unit 333 refers to the results of the calculations of the predicted numbers of sheets for printing in step S503 and the pre-paid plan management table in table 2 saved in the data storage unit 331. The contract management unit 333 selects pre-paid plans closest to the values of the predicted numbers of sheets for printing within the periods calculated in step S503 as recommended pre-paid plans within the respective periods. The contract management unit 333 may select pre-paid plans closest to the values of the predicted numbers of sheets for printing among charge plans having values greater than or equal to the values of the predicted numbers of sheets for printing as recommended pre-paid plans.

In step S505, the contract management unit 333 generates a UI that highlights the recommended pre-paid plans selected in step S504. Specifically, the contract management unit 333 generates a UI that highlights the recommended pre-paid plans, using frames indicating the recommended pre-paid plans and messages including use periods that match the recommended pre-paid plans. An example of this screen is the screen illustrated in FIG. 4B. The contract management unit 333 returns the generated UI to the data transmission/reception unit 321.

The processing flow of the client terminal 104 illustrated in the sequence diagram in FIG. 5A is described in FIG. 5C.

In step S531, the user interface unit 324 of the client terminal 104 detects an instruction to display the charge screen 402. Specifically, the user interface unit 324 detects that the user presses a predetermined button on a screen (not illustrated) displayed on the client terminal 104. The predetermined button is a button for transitioning to the charge screen 402. If the user interface unit 324 detects this instruction, then in step S532, the data transmission/reception unit 321 of the client terminal 104 requests the charge screen 402 from the print service 105. In step S533, the data transmission/reception unit 321 receives the charge screen 402 from the print service 105. In step S534, the user interface unit 324 performs display control to display the received charge screen 402.

In step S535, the user interface unit 324 detects the pressing of the “select recommended plans” button 416. If the user interface unit 324 detects this pressing, then in step S536, the data transmission/reception unit 321 requests the recommended charge screen 422 from the print service 105. In step S537, the data transmission/reception unit 321 receives the recommended charge screen 422 from the print service 105. In step S538, the user interface unit 324 performs display control to display the received recommended charge screen 422.

As described above, in the present exemplary embodiment, a description has been given of a method for, in a prepaid service where a user purchases the number of sheets for printing in advance, automatically presenting optimal pre-paid plans to the user. By this method, even in a prepaid service where a user purchases the number of sheets for printing in advance, it is easy to select optimal plans in terms of cost according to the user's use.

Although a form in which the client terminal 104 receives a screen from the print service 105 via the networks 100 and 101 and displays the screen has been described with reference to FIGS. 5A to 5C, the present disclosure is not limited to this. For example, the image forming apparatus 102 or 103 may generate a charge screen or a recommended charge screen and display the charge screen or the recommended charge screen via a web browser of the client terminal 104. That is, a remote UI of the image forming apparatuses 102 or 103 may display the charge screen or the recommended charge screen. Alternatively, a mobile app installed on the client terminal 104 may generate a charge screen or a recommended charge screen and display the charge screen or the recommended charge screen. In this case, each apparatus that generates the recommended charge screen may select recommended charge plans required to generate the recommended charge screen, or each apparatus may receive the results of selecting recommended charge plans by the print service 105. FIG. 5D illustrates a flowchart in which the image forming apparatus 102 or 103 or the mobile app performs processing also including the selection of recommended charge plans.

The flowchart in FIG. 5D starts if the image forming apparatus 102 or 103 or the mobile app receives an instruction to display the charge screen 402. Although the following description is given on the assumption that the image forming apparatus 102 performs the processing, the mobile app may perform the processing.

In step S510, the user interface unit 306 of the image forming apparatus 102 displays the charge screen 402. In step S511, the user interface unit 306 detects the pressing of the “select recommended plans” button 416. If the user interface unit 306 detects this pressing in step S511, the processing proceeds to step S512. The contents of the processes of steps S512 to S515 are similar to those of steps S502 to S505, except that the apparatus that performs the processing changes from the print service 105 to the image forming apparatus 102. The tables managed by the print service 105 are also saved in and managed by the image forming apparatus 102. In step S516, the user interface unit 306 displays the recommended charge screen 422.

In the first exemplary embodiment, a description has been given of a method for, in a prepaid service where a user purchases the number of sheets for printing in advance, automatically presenting optimal pre-paid plans to the user based on the average numbers of sheets for printing in devices owned by the user. However, a case is possible where a plan should be presented by reflecting each user's use.

In a second exemplary embodiment, a description is given of a method for automatically presenting an optimal pre-paid plan to a user, also taking into account an item regarding the user's use input by the user in addition to the average numbers of sheets for printing in devices owned by the user.

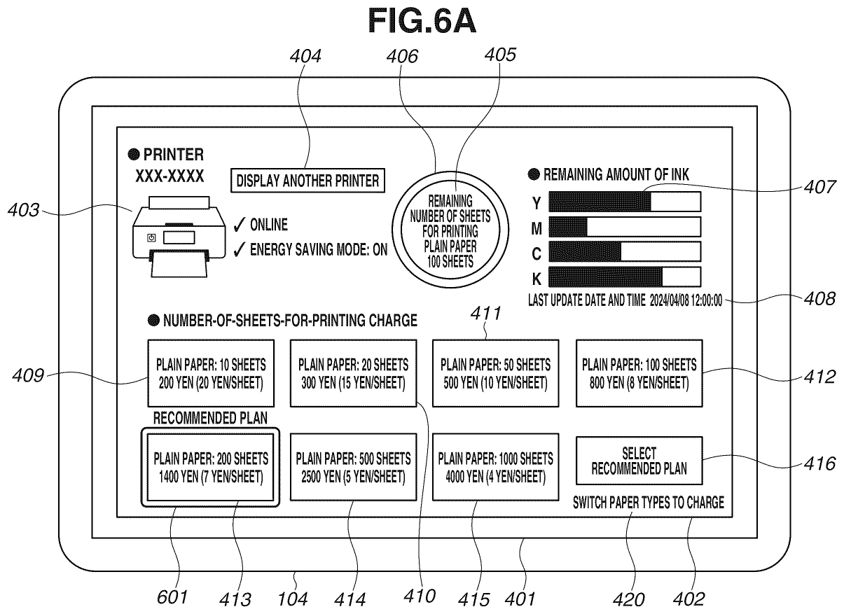

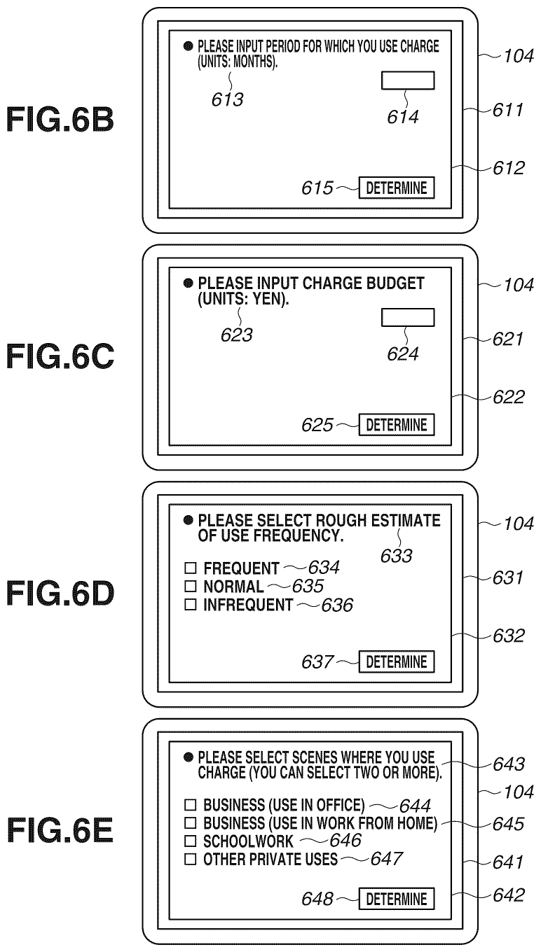

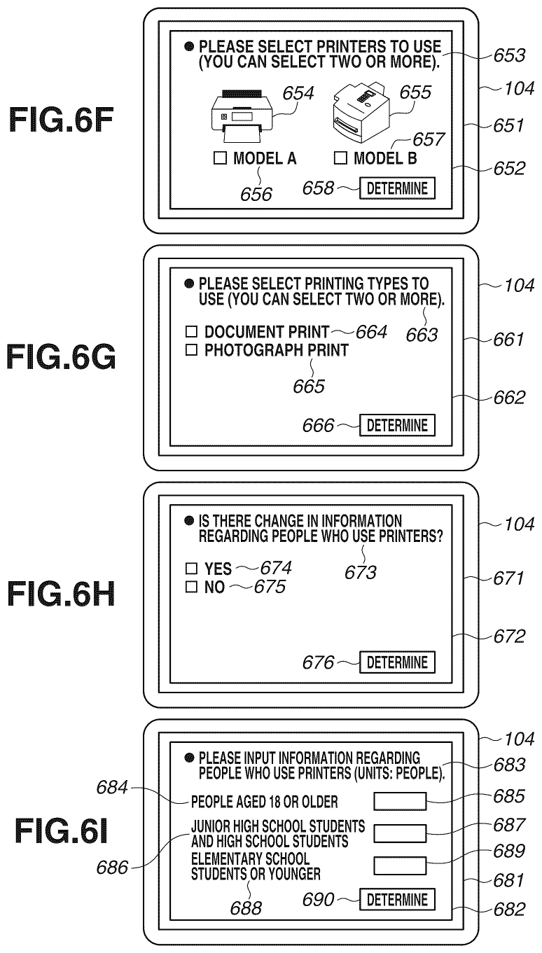

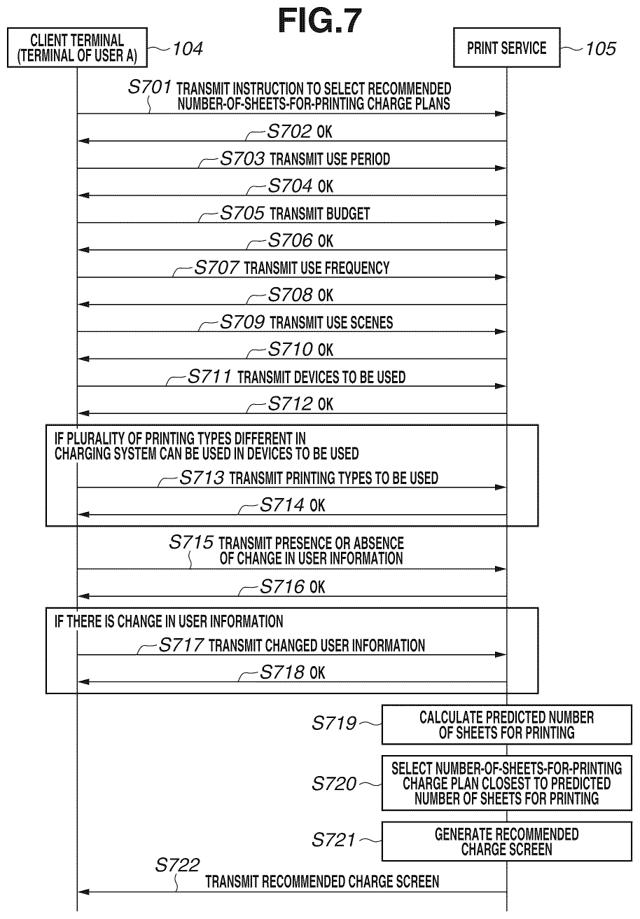

FIGS. 6A, 6B, 6C, 6D, 6E, 6F, 6G, 6H, and 6I illustrate examples of UIs displayed on the display unit 226 of the client terminal 104 according to the second exemplary embodiment and generated by the contract management unit 333 of the print service 105 according to the present exemplary embodiment. FIG. 7 is a sequence illustrating processing until a user acquires information regarding a pre-paid plan recommended to the user on a purchase screen for purchasing a pre-paid plan according to the second exemplary embodiment.

In the present exemplary embodiment, it is assumed that a user who operates the client terminal 104 is the user corresponding to the user A in the “user ID” column in each of tables 1 and 3. The user A is a user who uses the image forming apparatuses 102 and 103, the image forming apparatus 102 is the device corresponding to the device A in the “device ID” column in table 3, and the image forming apparatus 103 is the device corresponding to the device D in the “device ID” column in table 3.

First, FIG. 6A is described. The descriptions of the client terminal 104 and the items 401 to 416 and 420 in FIG. 6A are similar to those of the client terminal 104 and the items 401 to 416 and 420 in FIGS. 4A and 4B. An item 601 illustrates a frame indicating a recommended pre-paid plan and a message. Although FIG. 6A illustrates only “recommended plan”, the present disclosure is not limited to this. Similarly to FIG. 4B, information regarding a predetermined period may also be displayed with “recommended plan”. For example, information regarding a predetermined period input on a screen illustrated in FIG. 6B may also be displayed with “recommended plan”. The item 601 is displayed on the charge screen 402 after the pressing of the button 416 and inputs from the user on the screens in FIGS. 6B to 6I are received. According to the pressing of the button 416 and the input values of items regarding the user's use, a recommended pre-paid plan is selected. Then, the item 601 highlights any of the plans in the buttons 409, 410, 411, 412, 413, 414, and 415 selected as the recommended pre-paid plan. Consequently, the recommended pre-paid plan is displayed on the UI.

A display 611 in FIG. 6B is the display unit 226 of the client terminal 104 used by the user A and displays an example of a UI of a screen where the user A according to the present exemplary embodiment inputs a period for use in selecting a pre-paid plan recommended to the user A provided by the print service 105. A UI 612 is the example of the UI of the screen where the user A inputs a period for use in selecting a pre-paid plan recommended to the user A provided by the print service 105. An item 613 is a message specifying the content of an input to the user A and has a content giving an instruction to input in units of months a period for which the user A wishes to perform a number-of-sheets-for-printing charge. To a text box 614, the user A inputs the content specified in the item 613. A button 615 is a button for finalizing the content input to the text box 614 by the user A. If the button 615 is pressed, the screen 612 can transition to a screen 622 where the user A inputs a charge budget.

A display 621 in FIG. 6C is the display unit 226 of the client terminal 104 used by the user A and displays an example of a UI of a screen where the user A according to the present exemplary embodiment inputs a charge budget for use in selecting a pre-paid plan recommended to the user A provided by the print service 105. A UI 622 is the example of the UI of the screen where the user A inputs a charge budget for use in selecting a pre-paid plan recommended to the user A provided by the print service 105. An item 623 is a message specifying the content of an input to the user A and has a content giving an instruction to input a budget for a number-of-sheets-for-printing charge in units of yen. To a text box 624, the user A inputs the content specified in the item 623. A button 625 is a button for finalizing the content input to the text box 624 by the user A. If the button 625 is pressed, the screen 622 can transition to a screen 632 where the user A inputs a use frequency.

A display 631 in FIG. 6D is the display unit 226 of the client terminal 104 used by the user A and displays an example of a UI of a screen where the user A according to the present exemplary embodiment inputs a rough estimate of a use frequency for use in selecting a pre-paid plan recommended to the user A provided by the print service 105. A UI is the example of the UI of the screen 632 where the user A inputs a rough estimate of a use frequency for use in selecting a pre-paid plan recommended to the user A provided by the print service 105. An item 633 is a message specifying the content of an input to the user A and has a content giving an instruction to specify a rough estimate of a use frequency. To checkboxes 634, 635, and 636, the user A inputs the content specified in the item 633. The user A selects any of the checkboxes 634, 635, and 636 for a corresponding use frequency and thereby can specify the use frequency of the user A. The user A can select only a single checkbox among the checkboxes 634, 635, and 636. A button 637 is a button for finalizing the content input to any of the checkboxes 634, 635, and 636 by the user A. If the button 637 is pressed, the screen 632 can transition to a screen 642 where the user A inputs use scenes.

A display 641 in FIG. 6E is the display unit 226 of the client terminal 104 used by the user A and displays an example of a UI of a screen where the user A according to the present exemplary embodiment inputs use scenes of the devices of the user A for use in selecting a pre-paid plan recommended to the user A provided by the print service 105. A UI 642 is the example of the UI of the screen where the user A inputs use scenes of the devices of the user A for use in selecting a pre-paid plan recommended to the user A provided by the print service 105. An item 643 is a message specifying the content of an input to the user A and has a content giving an instruction to specify use scenes of the devices of the user A. To checkboxes 644, 645, 646, and 647, the user A inputs the content specified in the item 633. The user A selects any of the checkboxes 644, 645, 646, and 647 for corresponding use scenes of the devices and thereby can specify the use scenes of the devices of the user A. The user A can select a plurality of checkboxes among the checkboxes 644, 645, 646, and 647. A button 648 is a button for finalizing the content input to any of the checkboxes 644, 645, 646, and 647 by the user A. If the button 648 is pressed, the screen 642 can transition to a screen 652 where the user A inputs devices to be used by the user A.

A display 651 in FIG. 6F is the display unit 226 of the client terminal 104 used by the user A and displays an example of a UI of a screen where the user A according to the present exemplary embodiment inputs devices to be used by the user A for use in selecting a pre-paid plan recommended to the user A provided by the print service 105. A UI 652 is the example of the UI of the screen where the user A inputs devices to be used by the user A for use in selecting a pre-paid plan recommended to the user A provided by the print service 105. An item 653 is a message specifying the content of an input to the user A and has a content giving an instruction to specify devices to be used by the user A. Items 654 and 655 are an image of the image forming apparatus 102, which is the device corresponding to the device A in the “device ID” column in each of tables 3 and 4 used by the user, and an image of the image forming apparatus 103, which is the device corresponding to the device D in the “device ID” column in each of tables 3 and 4 used by the user. To checkboxes 656 and 657, the user A inputs the content specified in the item 653. The user A selects either of the checkboxes 656 and 657 in which the model names of corresponding devices are written, and thereby can specify the devices to be used by the user A. The user A can select a plurality of checkboxes between the checkboxes 656 and 657. A button 658 is a button for finalizing the content input to either of the checkboxes 656 and 657 by the user A. If the button 658 is pressed, and if a plurality of printing types different in charging system can be used in the devices to be used, the screen 652 transitions to an input screen 662 for inputting printing types to be used by the user A. If not, the screen 652 can transition to an input screen 672 for inputting the presence or absence of a change in user information.

A display 661 in FIG. 6G is the display unit 226 of the client terminal 104 used by the user A and displays an example of a UI of a screen where the user A according to the present exemplary embodiment inputs printing types to be used by the user A for use in selecting a pre-paid plan recommended to the user A provided by the print service 105. A UI 662 is the example of the UI of the screen where the user A inputs printing types to be used by the user A for use in selecting a pre-paid plan recommended to the user A provided by the print service 105. An item 663 is a message specifying the content of an input to the user A and has a content giving an instruction to specify printing types to be used by the user A. To checkboxes 664 and 665, the user A inputs the content specified in the item 653. The user A selects either of the checkboxes 664 and 665 in which printing types to be used are written, and thereby can specify the printing types to be used by the user A. The user A can select a plurality of checkboxes between the checkboxes 664 and 665. A button 666 is a button for finalizing the content input to either of the checkboxes 664 and 665 by the user A. If the button 666 is pressed, the screen 662 transitions to a screen 672 for inputting the presence or absence of a change in user information regarding the user A.

A display 671 in FIG. 6H is the display unit 226 of the client terminal 104 used by the user A and displays an example of a UI of a screen where the user A according to the present exemplary embodiment inputs the presence or absence of a change in the user information regarding the user A for use in selecting a pre-paid plan recommended to the user A provided by the print service 105. A UI 672 is the example of the UI of the screen where the user A inputs the presence or absence of a change in the user information regarding the user A for use in selecting a pre-paid plan recommended to the user A provided by the print service 105. An item 673 is a message specifying the content of an input to the user A and has a content giving an instruction to specify the presence or absence of a change in the user information. To checkboxes 674 and 675, the user A inputs the content specified in the item 673. The user A selects corresponding one of the checkboxes 674 and 675 and thereby can specify the presence or absence of a change in the user information regarding the user A. The user A can select only a single checkbox between the checkboxes 674 and 675. A button 676 is a button for finalizing the content input to either of the checkboxes 674 and 675 by the user A. If the button 676 is pressed, and if there is a change in the user information, the screen 672 transitions to a registration screen 682 for registering the user information. If there is not a change in the user information, the predicted value of the number of sheets for printing by the user A is calculated, and a recommended pre-paid plan is selected. Then, the screen 672 transitions to the screen 402 where the user A purchases a number-of-sheets-for-printing charge provided by the print service 105.

A display 681 in FIG. 6I is the display unit 226 of the client terminal 104 used by the user A and displays an example of a UI of a screen where the user A according to the present exemplary embodiment inputs the user information regarding the user A for use in selecting a pre-paid plan recommended to the user A provided by the print service 105. A UI 682 is the example of the UI of the screen where the user A inputs the user information regarding the user A for use in selecting a pre-paid plan recommended to the user A provided by the print service 105. An item 683 is a message specifying the content of an input to the user A and has a content giving an instruction to specify the user information. Text 684, 686, and 688 specifies the names of items to be input by the user A. To text boxes 685, 687, and 689, the items specified in the items 683, 684, 686, and 688 are input. The user A provides an input to any of the text boxes 685, 687, and 689 and thereby can specify the user information regarding the user A. The user A can provide inputs to one or more text boxes among the text boxes 685, 687, and 689. A button 690 is a button for finalizing the content input to any of the text boxes 685, 687, and 689 by the user A. The user information regarding the user A is saved, the predicted value of the number of sheets for printing by the user A is calculated, and a recommended pre-paid plan is selected. Then, the screen 682 transitions to the screen 402 where the user A purchases a number-of-sheets-for-printing charge provided by the print service 105.

With reference to a sequence diagram in FIG. 7, an overall processing flow is described.

In step S701, the client terminal 104 detects that the button 416 for giving an instruction to select a recommended pre-paid plan on the screen 402 for purchasing a number-of-sheets-for-printing charge is pressed. The data transmission/reception unit 321 of the client terminal 104 of the user A transmits the instruction to select a recommended pre-paid plan input through the user interface unit 324 to the data transmission/reception unit 337. In step S702, the data transmission/reception unit 337 transmits the instruction to select a recommended pre-paid plan to the contract management unit 333 and returns a result indicating success of the instruction to select a pre-paid plan and an instruction to display the screen 612.

In step S703, the client terminal 104 of the user A displays the screen 612. The client terminal 104 of the user A receives the input of a period for use in selecting a recommended pre-paid plan to the text box 614 on the screen 612. The client terminal 104 of the user A detects that the period is input and the button 615 for finalizing the content of the input is pressed. The data transmission/reception unit 321 of the client terminal 104 of the user A transmits the period for use in selecting a recommended pre-paid plan input through the user interface unit 324 to the data transmission/reception unit 337. In step S704, the data transmission/reception unit 337 transmits the period for use in selecting a recommended pre-paid plan to the contract management unit 333 and returns a result indicating success of the input of the period for use in selecting a pre-paid plan and an instruction to display the screen 622.

In step S705, the client terminal 104 of the user A displays the screen 622. The client terminal 104 of the user A receives the input of a budget for use in selecting a recommended pre-paid plan to the text box 624 on the screen 622. The client terminal 104 of the user A detects that the budget is input and the button 625 for finalizing the content of the input is pressed. The data transmission/reception unit 321 of the client terminal 104 of the user A transmits the budget for use in selecting a recommended pre-paid plan input through the user interface unit 324 to the data transmission/reception unit 337. In step S706, the data transmission/reception unit 337 transmits the budget for use in selecting a recommended pre-paid plan to the contract management unit 333 and returns a result indicating success of the input of the budget for use in selecting a pre-paid plan and an instruction to display the screen 632.

In step S707, the client terminal 104 of the user A displays the screen 632. The client terminal 104 of the user A selects any of the checkboxes 634, 635, and 636 on the screen 632 and receives the input of a rough estimate of a use frequency for use in selecting a recommended pre-paid plan. The client terminal 104 of the user A detects that the rough estimate of the use frequency is input and the button 637 for finalizing the content of the input is pressed. The data transmission/reception unit 321 of the client terminal 104 of the user A transmits the rough estimate of the use frequency for use in selecting a recommended pre-paid plan input through the user interface unit 324 to the data transmission/reception unit 337. In step S708, the data transmission/reception unit 337 transmits the rough estimate of the use frequency for use in selecting a recommended pre-paid plan to the contract management unit 333 and returns a result indicating success of the input of the rough estimate of the use frequency for use in selecting a pre-paid plan and an instruction to display the screen 642.

In step S709, the client terminal 104 of the user A displays the screen 642. The client terminal 104 of the user A detects that any of the checkboxes 644, 645, 646, and 647 on the screen 642 is selected. That is, the client terminal 104 of the user A receives the input of use scenes for use in selecting a recommended pre-paid plan. The client terminal 104 of the user A detects that the use scenes are input and the button 648 for finalizing the content of the input is pressed. The data transmission/reception unit 321 of the client terminal 104 of the user A transmits the use scenes for use in selecting a recommended pre-paid plan input through the user interface unit 324 to the data transmission/reception unit 337. In step S710, the data transmission/reception unit 337 transmits the use scenes for use in selecting a recommended pre-paid plan to the contract management unit 333 and returns a result indicating success of the input of the use scenes for use in selecting a pre-paid plan and an instruction to display the screen 652.

In step S711, the client terminal 104 of the user A displays the screen 652. The client terminal 104 of the user A receives the selection of either of the checkboxes 656 and 657 on the screen 652. That is, The client terminal 104 of the user A receives the input of the models of devices for use in selecting a recommended pre-paid plan. The client terminal 104 of the user A detects that the models are input and the button 658 for finalizing the content of the input is pressed. The data transmission/reception unit 321 of the client terminal 104 of the user A transmits the models of the devices for use in selecting a recommended pre-paid plan input through the user interface unit 324 to the data transmission/reception unit 337. In step S712, the data transmission/reception unit 337 transmits the models of the devices for use in selecting a recommended pre-paid plan to the contract management unit 333. Further, the contract management unit 333 checks printing types with which the devices selected in step S706 are compatible. The contract management unit 333 refers to the average-number-of-sheets-for-printing-per-month-with-respect-to-each-model management table in table 4 saved in the data storage unit 331. If the devices selected in step S711 are compatible with a plurality of printing types different in charging system, the contract management unit 333 returns success of the input of the devices and an instruction to display the screen 662. Specifically, the contract management unit 333 returns success of the input of the devices and an instruction to display the screen 662 to the data transmission/reception unit 321 of the client terminal 104 via the data transmission/reception unit 337. If the devices selected in step S706 are incompatible with a plurality of printing types different in charging system, the contract management unit 333 returns success of the input of the devices and an instruction to display the screen 672 to the data transmission/reception unit 321 of the client terminal 104 via the data transmission/reception unit 337.

Step S713 is executed only if the data transmission/reception unit 321 of the client terminal 104 receives the instruction to display the screen 662 in step S712. In step S713, the client terminal 104 of the user A displays the screen 662. The client terminal 104 of the user A receives the selection of either of the checkboxes 664 and 665 on the screen 662. That is, the client terminal 104 of the user A receives the input of printing types for use in selecting a recommended pre-paid plan. The client terminal 104 of the user A detects that the printing types are input and the button 666 for finalizing the content of the input is pressed. The data transmission/reception unit 321 of the client terminal 104 of the user A transmits the printing types for use in selecting a recommended pre-paid plan input through the user interface unit 324 to the data transmission/reception unit 337. In step S714, the data transmission/reception unit 337 transmits the printing types for use in selecting a recommended pre-paid plan to the contract management unit 333. The data transmission/reception unit 337 returns a result indicating success of the input of the printing types for use in selecting a pre-paid plan and an instruction to display the screen 672.

In step S715, the client terminal 104 of the user A displays the screen 672. The client terminal 104 of the user A receives the selection of either of the checkboxes 674 and 675 on the screen 672. That is, the client terminal 104 of the user A receives the input of the presence or absence of a change in device user information. The client terminal 104 of the user A detects that the presence or absence of a change is input and the button 676 for finalizing the content of the input is pressed. The data transmission/reception unit 321 of the client terminal 104 of the user A transmits the presence or absence of a change in the device user information input through the user interface unit 324 to the data transmission/reception unit 337. In step S716, the data transmission/reception unit 337 transmits the presence or absence of a change in the device user information to the user management unit 332. If there is a change in the device user information, the user management unit 332 returns success of the input of the presence or absence of a change in the user information and an instruction to display the screen 682 to the data transmission/reception unit 321 of the client terminal 104 via the data transmission/reception unit 337. If there is not a change in the device user information, the user management unit 332 returns success of the input of the presence or absence of a change in the user information. If there is not a change in the device user information, the user management unit 332 transmits the device user information to the contract management unit 333.

Step S717 is executed only if the data transmission/reception unit 321 of the client terminal 104 receives the instruction to display the screen 682 in step S716. In step S717, the client terminal 104 of the user A displays the screen 682. The client terminal 104 of the user A receives the input of the numbers of users who use the user A in a shared manner to any of the text boxes 685, 687, and 689 on the screen 682. The client terminal 104 of the user A detects that the numbers of users are input and the button 690 for finalizing the content of the input is pressed. The data transmission/reception unit 321 of the client terminal 104 of the user A transmits the user information regarding the devices input through the user interface unit 324 to the data transmission/reception unit 337. In step S718, the data transmission/reception unit 337 transmits the user information regarding the devices to the user management unit 332. The user management unit 332 updates the user management table in table 1 using the transmitted user information regarding the devices and notifies the contract management unit 333 of the updated user information regarding the devices. Further, the user management unit 332 transmits success of the update of the user information regarding the devices to the data transmission/reception unit 321 of the client terminal 104 via the data transmission/reception unit 337.

Although this sequence diagram illustrates an example where in the user information input processes in steps S702 to S718, each piece of information is input on a different screen, a plurality of pieces of information may be input on the same screen, or some of the items may not be input.

In step S719, the contract management unit 333 calculates the predicted number of sheets for printing. If the printing types are specified in step S711, the contract management unit 333 calculates the predicted number of sheets for printing with respect to each specified printing type. If not, the contract management unit 333 calculates the predicted number of sheets for printing for only a single printing type that can be used for printing. The contract management unit 333 calculates the predicted number of sheets for printing by referring to the contract state management table in table 3 and the average-number-of-sheets-for-printing-per-month-with-respect-to-each-model management table in table 4 saved in the data storage unit 331. The predicted number of sheets for printing is obtained by a calculation formula A×B×C×D+E. A is the total average number of sheets used by the devices selected in step S711. B is the period input in step S703. C is a correction parameter (1.2 for frequent, 1 for normal, and 2 for infrequent) based on the use frequency. D is a correction parameter (0.8 per person for junior high school students and high school students, and 0.5 per person for elementary school students or younger) based on the user attributes. E is the additional number of sheets according to the use purpose. In the case of document printing, the additional number of sheets is the addition of 100 sheets for office use, the addition of 50 sheets for use in work from home, or the addition of 20 sheets for use for a learning purpose. In the case of photograph printing, the additional number of sheets is the addition of 10 sheets for office use, or the addition of 5 sheets for use in work from home and for a learning purpose. If information regarding the period is not input, similarly to the first exemplary embodiment, the predicted numbers of sheets for printing within a plurality of periods are calculated. If information regarding the devices to be used is not input, similarly to the first exemplary embodiment, the predicted number of sheets for printing is calculated using the total average number of sheets used by all the devices with which the user A is under contract. If there is an item that is not input among items other than the period and the devices to be used, the predicted number of sheets for printing is calculated by setting a correction parameter for the corresponding item to 1.

Further, regarding a user who has been continuously using the print service 105 for a year or more, the contract management unit 333 refers to the printing actual result value table in table 7 managed by the printing history management unit 335. The contract management unit 333 calculates how many times as much as the predicted value of the number of sheets for printing the actual result value of the printing amount over the past year is. Then, the contract management unit 333 multiplies the predicted value of the number of sheets for printing by the calculation result as a correction parameter unique to the user. The contract management unit 333 divides the calculated predicted value of the number of sheets for printing by the period input in step S703 and saves the calculation result as the predicted value of the number of sheets for printing per month for the period input in step S703 from the current month in the printing actual result value table in table 7 managed by the printing history management unit 335.

In step S720, the contract management unit 333 refers to the result of the calculation of the predicted number of sheets for printing in step S719 and the pre-paid plan management table in table 2 saved in the data storage unit 331. The contract management unit 333 selects a pre-paid plan closest to the value of the predicted number of sheets for printing calculated in step S719 in the range where the total price of a number-of-sheets-for-printing charge is within +10% of the budget specified in step S705 as a recommended pre-paid plan. The contract management unit 333 may select a pre-paid plan closest to the value of the predicted number of sheets for printing among charge plans having values greater than or equal to the value of the predicted number of sheets for printing as a recommended pre-paid plan.

In step S721, the contract management unit 333 generates the screen 402 that highlights the recommended pre-paid plan selected in step S719, using a frame indicating the recommended pre-paid plan and the item (message) 601. The screen 402 displayed in this step is the screen 402 illustrated in FIG. 6A.

In step S722, the contract management unit 333 returns the generated screen 402 to the data transmission/reception unit 321 of the client terminal 104 via the data transmission/reception unit 337.

As described above, in the present exemplary embodiment, regarding a method for, in a prepaid service where a user purchases the number of sheets for printing in advance, automatically presenting an optimal pre-paid plan to the user, a description has been given of a method for presenting a plan by also reflecting each user's use. By this method, even in a prepaid service where a user purchases the number of sheets for printing in advance, it is easy to select an optimal plan in terms of cost according to the situation of an individual user.

A flowchart for the client terminal 104 according to the second exemplary embodiment is not illustrated, but is similar to that in FIG. 5C described in the first exemplary embodiment. In the second exemplary embodiment, the processes of steps S702 to S718 and the display processes for displaying the screens in FIGS. 6B to 6I are additionally performed between steps S536 and S537. Although a flowchart for the print service 105 according to the second exemplary embodiment is not illustrated, the print service 105 performs processing as described with reference to the sequence diagram in FIG. 7.

In FIG. 7, a form has been described in which the print service 105 generates a screen, and the print service 105 transmits the screen to the client terminal 104. The present disclosure, however, is not limited to this.

For example, in step S721, the print service 105 may not generate the screen, and in step S722, the print service 105 may transmit information regarding a recommended charge plan to the client terminal 104. Then, the client terminal 104 may receive the information, generate the recommended charge screen 402 based on the information, and display the recommended charge screen 402. For example, the information regarding the recommended charge plan transmitted from the print service 105 to the client terminal 104 is information regarding a predetermined period and information regarding a charge plan for the number of sheets estimated to be used for printing within the predetermined period.

In FIG. 7, a form has been described in which the input results of the screens are transmitted on a screen-by-screen basis in steps S701 to S718. In this form, if the input result of a previous screen is transmitted, an instruction to display a next screen is transmitted from the print service 105. The present disclosure, however, is not limited to this. The client terminal 104 may display the screens in FIGS. 6B to 6I without communicating with the print service 105 each time. In this case, data of the screens illustrated in FIGS. 6A to 6I is saved in advance in the client terminal 104. After all the screens are displayed, the client terminal 104 may collectively transmit the input data to the print service 105. Based on the collectively transmitted data, the print service 105 calculates the predicted number of sheets for printing in step S719.

Although a form in which the client terminal 104 receives a screen from the print service 105 via the networks 100 and 101 and displays the screen has been described with reference to FIG. 7, the present disclosure is not limited to this. For example, the image forming apparatus 102 or 103 may generate a charge screen or a recommended charge screen and display the charge screen or the recommended charge screen via a web browser of the client terminal 104.

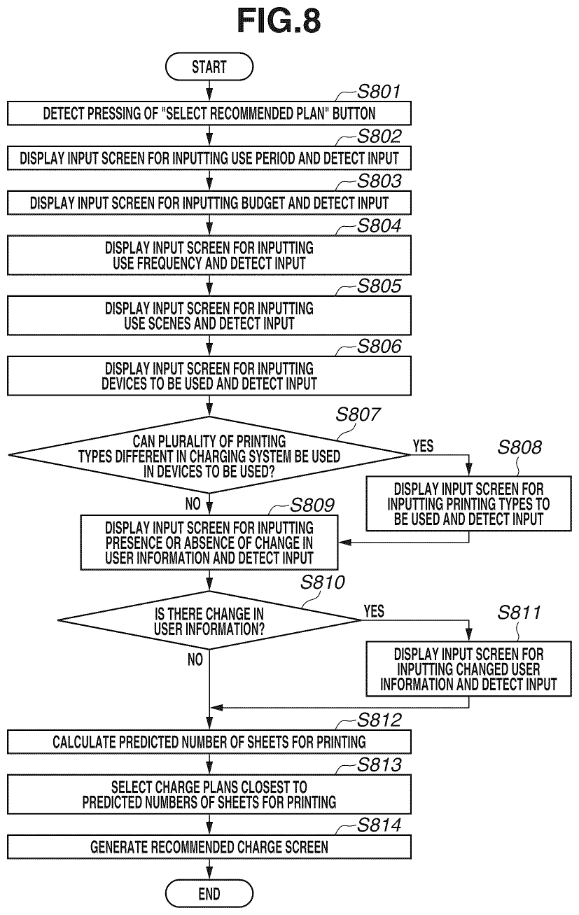

That is, a remote UI of the image forming apparatus 102 or 103 may display the charge screen or the recommended charge screen. Alternatively, a mobile app installed on the client terminal 104 may generate a charge screen or a recommended charge screen and display the charge screen or the recommended charge screen. In this case, each apparatus that generates the recommended charge screen may select a recommended charge plan required to generate the recommended charge screen, or each apparatus may receive the result of selecting a recommended charge plan by the print service 105. FIG. 8 illustrates a flowchart in which the image forming apparatus 102 or 103 or the mobile app performs processing also including the selection of a recommended charge plan.

The flowchart in FIG. 8 illustrates alternative processes to the processes of steps S511 to S515 in the flowchart in FIG. 5D described in the first exemplary embodiment. Step S801 is similar to step S511.

In steps S802 to S806, the screens illustrated in FIGS. 6B to 6F, respectively, are displayed, inputs on the screens are detected, and the processing proceeds to the next processes. In step S807, it is determined whether a plurality of printing types different in charging system can be used in the devices to be used. If a plurality of printing types can be used (YES in step S807), the processing proceeds to step S808. If a plurality of printing types cannot be used (NO in step S807), the processing proceeds to step S809. In steps S808 and S809, the screens illustrated in FIGS. 6G and 6H, respectively, are displayed, inputs on the screens are detected, and the processing proceeds to the next processes. In step S810, it is determined whether there is a change in the user information. If there is a change (YES in step S810), the processing proceeds to step S811. In step S811, the screen illustrated in FIG. 6I is displayed, and an input on the screen is detected, and the processing proceeds to the next process. In steps S812 to S814, processes similar to those of steps S719 to S721 are performed.

The tables used in the determinations in steps S807 and S810 are also saved in and managed by the image forming apparatus 102.

In the first and second exemplary embodiments, descriptions have been given of exemplary embodiments in which information such as “recommended plan” is displayed in association with an option indicating the number of sheets for printing estimated to be used for printing within a predetermined period. In a third exemplary embodiment, a configuration is described in which if a single option is specified on a recommended charge screen, information regarding a period estimated to be required for printing on the number of sheets for printing indicated in the specified option is displayed.

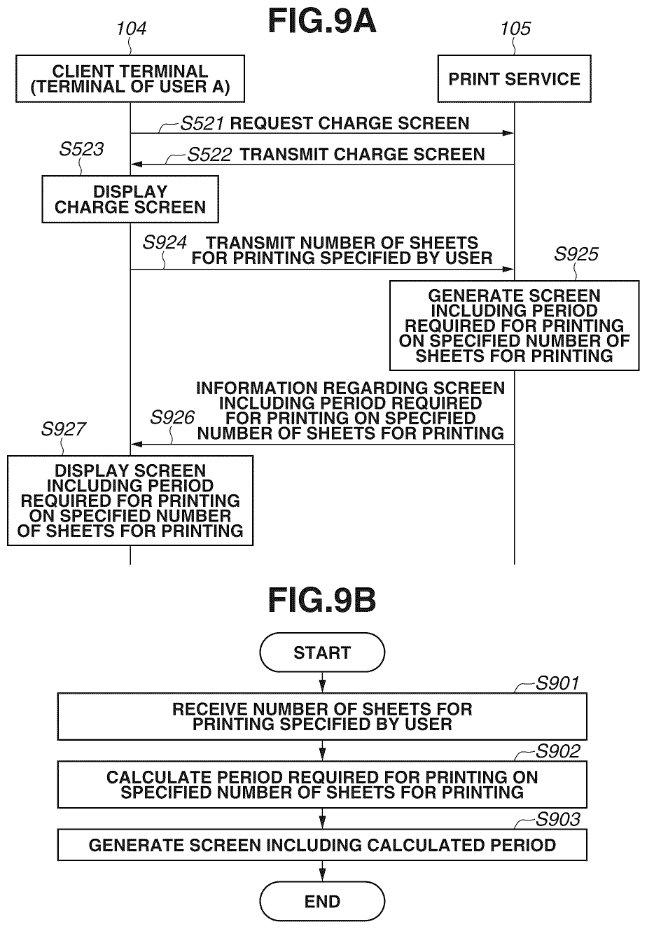

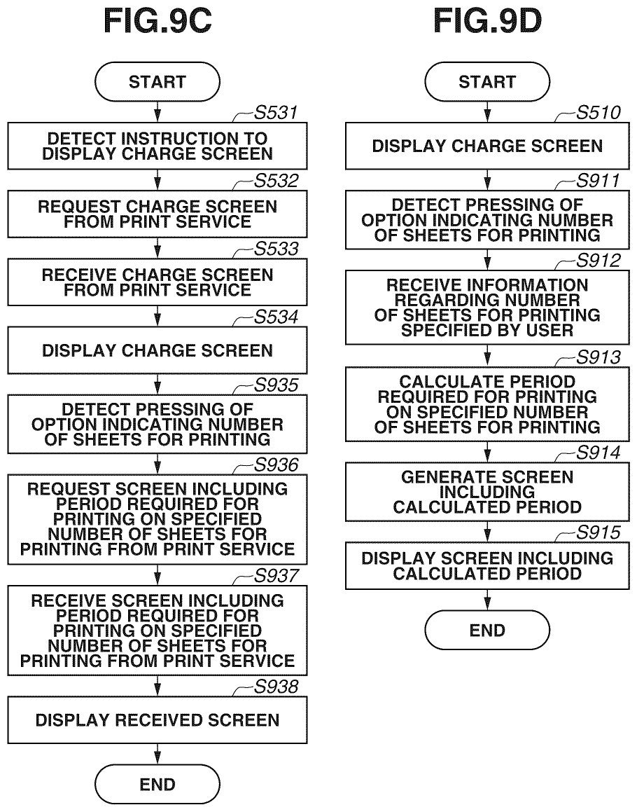

With reference to FIGS. 9A to 9D, processing according to the present exemplary embodiment is described. Processes common to FIGS. 5A to 5D and 9A to 9D are designated by the same numbers, and are not described in detail. First, with reference to FIG. 9A, an overall sequence is described.

The processes of steps S521 to S523 are similar to those in FIG. 5A. In step S924, the client terminal 104 transmits information regarding the number of sheets for printing specified by the user to the print service 105. In step S925, the print service 105 generates a screen including a period required for printing on the specified number of sheets for printing (not illustrated). The detailed processing will be described with reference to FIG. 9B. In step S926, the print service 105 transmits the generated screen to the client terminal 104. In step S927, the client terminal 104 displays the received screen.

In FIG. 9A, a form has been described in which the print service 105 generates a screen, and the print service 105 transmits the screen to the client terminal 104. The present disclosure, however, is not limited to this. For example, in step S925, the print service 105 may not generate the screen, and in step S926, the print service 105 may transmit information regarding a period required for printing on the specified number of sheets for printing to the client terminal 104. The client terminal 104 may receive the information, generate the screen based on the information, and display the screen. Alternatively, the client terminal 104 may display the information on top of the charge screen 402.

With reference to FIG. 9B, the processing flow of the print service 105 in steps S924 and S925 is described. Before this flow, any of the buttons 409 to 416 for pre-paid plans on the screen 402 for purchasing a number-of-sheets-for-printing charge displayed on the client terminal 104 of the user A is pressed. This flow is started if the data transmission/reception unit 321 of the client terminal 104 of the user A transmits information regarding the number of sheets for printing indicated in the pressed option to the data transmission/reception unit 337. This flow is processing performed by the components of the print service 105.

In step S901, the data transmission/reception unit 337 receives the information regarding the number of sheets for printing specified by the user and transmits the received information to the contract management unit 333. In step S901, the data transmission/reception unit 337 also receives a printing sheet type specified by the user.

In step S902, the contract management unit 333 calculates a period required for printing on the received number of sheets for printing. Specifically, the predicted number of sheets for printing is calculated as follows. The contract management unit 333 refers to the contract state management table in table 3 and the average-number-of-sheets-for-printing-per-month-with-respect-to-each-model management table in table 4 saved in the data storage unit 331 regarding the received printing sheet type. The contract management unit 333 calculates the received number of sheets for printing÷the average number of sheets for printing per month. By this calculation, a period estimated to be required for printing on the received number of sheets for printing is calculated. The process of rounding up the calculated period, rounding down the calculated period, or rounding off the calculated period to the left of the decimal point may be performed.

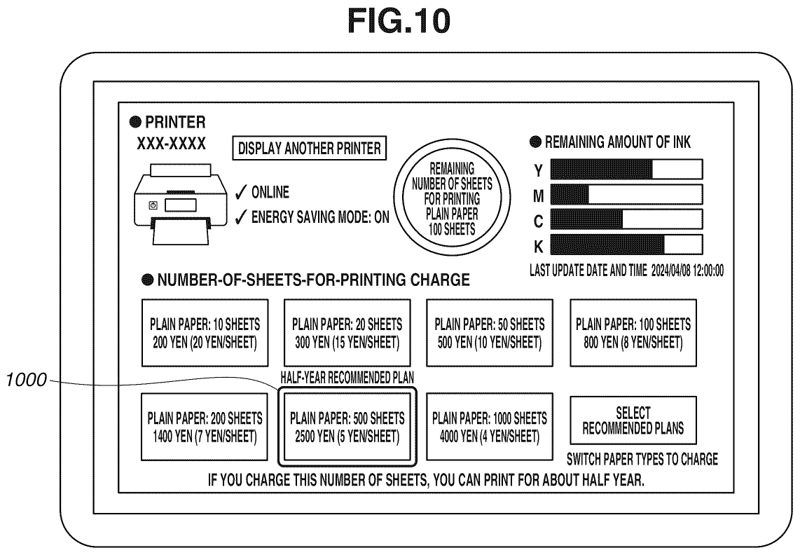

In step S903, the contract management unit 333 generates a UI including information regarding the period calculated in step S902. FIG. 10 illustrates an example of the generated UI. For example, the words “if you charge this number of sheets, you can print for about N months” are displayed in association with the option indicating the specified number of sheets for printing on the screen 402. Alternatively, the words “it takes N months to print this number of sheets” are displayed. N is the number of the period calculated in step S902. The words are not limited to these words. For example, the words may only need to suggest that it takes N months to consume the specified number of sheets for printing. The words may be displayed in a pop-up manner on the screen 402.

With reference to FIG. 9C, the processing flow of the client terminal 104 illustrated in the sequence diagram in FIG. 9A is described. The processes of steps S531 to S534 are similar to those in FIG. 5C.

In step S935, the user interface unit 324 detects the pressing of any of the buttons 409 to 416 for pre-paid plans on the screen 402. If the user interface unit 324 detects this pressing, then in step S936, the data transmission/reception unit 321 requests a screen including a period required for printing on the specified number of sheets for printing from the print service 105. In step S937, the data transmission/reception unit 321 receives the screen including the period required for printing on the specified number of sheets for printing from the print service 105. In step S938, the user interface unit 324 performs display control to display the received screen.

As described above, in the present exemplary embodiment, a description has been given of a method for, in a prepaid service where a user purchases the number of sheets for printing in advance, performing display that allows the user to select an optimal pre-paid plan. By this method, even in a prepaid service where a user purchases the number of sheets for printing in advance, it is easy to select an optimal plan in terms of cost according to the user's use.

Although a form in which the client terminal 104 receives a screen from the print service 105 via the networks 100 and 101 and displays the screen has been described with reference to FIGS. 9A to 9C, the present disclosure is not limited to this. For example, the image forming apparatus 102 or 103 may generate a charge screen or a screen including a period and display the charge screen or the screen including the period via a web browser of the client terminal 104. That is, a remote UI of the image forming apparatus 102 or 103 may display the charge screen or the screen including the period. Alternatively, a mobile app installed on the client terminal 104 may generate a charge screen or a screen including a period and display the charge screen or the screen including the period. In this case, each apparatus that generates the screen including the period may select a charge plan required to generate the screen including the period, or each apparatus may receive the result of selecting a charge plan by the print service 105. FIG. 9D illustrates a flowchart in which the image forming apparatus 102 or 103 or the mobile app performs processing also including the selection of a charge plan.

The flowchart in FIG. 9D starts if the image forming apparatus 102 or 103 or the mobile app receives an instruction to display the charge screen 402. Although the following description is given on the assumption that the image forming apparatus 102 performs the processing, the mobile app may perform the processing.

In step S510, the user interface unit 306 of the image forming apparatus 102 displays the charge screen 402. In step S911, the user interface unit 306 detects the pressing of any of the buttons 409 to 416 for pre-paid plans on the screen 402. If the user interface unit 306 detects this pressing in step S911, the processing proceeds to step S912. The contents of the processes of steps S912 to S914 are similar to those of steps S901 to S903, except that the apparatus that performs the processing changes from the print service 105 to the image forming apparatus 102. The tables managed by the print service 105 are also saved in and managed by the image forming apparatus 102. In step S916, the user interface unit 306 displays the screen including the calculated period.

The present disclosure can also be achieved by the process of supplying a program for achieving one or more functions of the above exemplary embodiments to a system or an apparatus via a network or a storage medium, and of causing one or more processors in a computer of the system or the apparatus to read and execute the program. The present disclosure can also be achieved by a circuit (e.g., an application-specific integrated circuit (ASIC) or a field-programmable gate array (FPGA)) for achieving the one or more functions.

According to the present disclosure, it is possible to provide a mechanism for, when a user adds the number of sheets that can be used for printing in a printer, making it easy for the user to grasp an option for an appropriate number of sheets.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2024-101545, filed Jun. 24, 2024, and No. 2025-060810, filed Apr. 1, 2025, which are hereby incorporated by reference herein in their entirety.

What is claimed is:

1. An information processing apparatus comprising:
at least one memory that stores a program; and
at least one processor that, upon execution of the stored program, causes the at least one processor executes the program to:
cause display of a plurality of options indicating different numbers of sheets for adding a number of sheets permitted to be used for printing by a printer; and
cause display, in association with a single option among the plurality of options, of information regarding a period corresponding to a number of sheets indicated in the single option.

2. The information processing apparatus according to claim 1, wherein execution of the stored program further causes the at least one processor to further perform control to further display information regarding another period corresponding to the number of sheets indicated in another option different from the single option among the plurality of options in association with the other option.

3. The information processing apparatus according to claim 1, wherein execution of the stored program further causes the at least one processor to further perform control to display, in association with the single option among the plurality of options, information indicating that the single option is a recommended option in addition to the information regarding the period corresponding to the number of sheets indicated in the single option.

4. The information processing apparatus according to claim 1, wherein execution of the stored program further causes the at least one processor to further perform control to receive a user instruction to specify the period.

5. The information processing apparatus according to claim 4, wherein the single option is an option indicating a number of sheets estimated to be used for printing within the period.

6. The information processing apparatus according to claim 5, wherein execution of the stored program further configures the at least one processor to receive, from the user an input of information regarding any one of or more than one of a maximum value of price that is used for adding the number of sheets permitted to be used for printing in the printer, a use frequency of the printer, a scene where the printer is used, a model of the printer, a type of printing to be executed in printing by the printer, and a user of the printer.

7. The information processing apparatus according to claim 6, wherein the number of sheets estimated to be used for printing within the period in the printer is estimated based on the input information.

8. The information processing apparatus according to claim 1, wherein the information regarding the period is displayed in a case where a predetermined button displayed on a screen including the plurality of options indicating the different numbers of sheets is pressed.

9. The information processing apparatus according to claim 1, wherein the period is a period estimated to be required for printing performed on the number of sheets indicated in the single option.

10. The information processing apparatus according to claim 1, wherein the plurality of options indicating the different numbers of sheets indicates prices to be paid by a user to add the numbers of sheets indicated in the plurality of options to the numbers of sheets permitted to be used for printing in the printer.

11. The information processing apparatus according to claim 1, wherein the plurality of options indicating the different numbers of sheets indicates prices to be paid by a user to add the number of sheets indicated in the plurality of options to the numbers of sheets permitted to be used for printing in the printer, and the prices per sheet calculated based on the indicated prices and the indicated numbers of sheets.

12. The information processing apparatus according to claim 11,
wherein the amounts of money per sheet differ among the plurality of options, and
wherein the greater the number of sheets indicated in the option is, the smaller the price per sheet is.

13. The information processing apparatus according to claim 1,
wherein the information processing apparatus is the printer, and
wherein control is performed to perform display via a web browser of a personal computer.

14. A control method for controlling an information processing apparatus, the control method comprising:
causing display of a plurality of options indicating different numbers of sheets for adding a number of sheets permitted to be used for printing by a printer; and
cause display, in association with a single option among the plurality of options, of information regarding a period corresponding to a number of sheets indicated in the single option.

15. A non-transitory storage medium that stores a computer program that, when executed by one or more processors, performs a control method for controlling an information processing apparatus, the control method comprising:
performing control to display a plurality of options indicating different numbers of sheets for adding a number of sheets permitted to be used for printing in a printer; and
performing control to, in association with a single option among the plurality of options, display information regarding a period corresponding to a number of sheets indicated in the single option.
